(19) United States
(12) Patent Application Publication
(10) Pub. No.: US 2022/0319189 A1
(43) Pub. Date: Oct. 6, 2022

(54) OBSTACLE TRACKING METHOD, STORAGE MEDIUM, AND ELECTRONIC DEVICE

(71) Applicant: Beijing Sankuai Online Technology Co., Ltd., Beijing (CN)

(72) Inventors: Huaxia XIA, Beijing (CN); Shanbo CAI, Beijing (CN)

(21) Appl. No.: 17/669,364

(22) Filed: Feb. 11, 2022

(30) Foreign Application Priority Data
Apr. 6, 2021 (CN) 202110364553.5

(51) Int. Cl. G06V 20/58; G06T 7/20; G06V 10/74

(52) U.S. Cl. CPC G06V 20/58; G06T 7/20; G06V 10/761; G06T 2207/10028; G06T 2207/30261

(57) ABSTRACT

An obstacle tracking method, a storage medium, and an electronic device are provided. In various embodiments for obstacles in every two frames of laser point clouds, first, the obstacles in the two frames of laser point clouds are matched according to types of the obstacles in the two frames of laser point clouds. Next, unmatched obstacles in the two frames of laser point clouds are matched according to point cloud data of the unmatched obstacles in the two frames of laser point clouds. After two times of matching, motion states of the obstacles in the two frames of laser point clouds are updated.

### CROSS-REFERENCE TO RELATED APPLICATIONS

This application claims priority to Chinese Patent Application No. 202110364553.5 filed on Apr. 6, 2020, which is incorporated by reference herein in its entirety.

### TECHNICAL FIELD

This specification relates to the field of computer technologies, and in particular to an obstacle tracking method, a storage medium, and an electronic device.

### BACKGROUND

In the field of unmanned driving, the most fundamental requirement for an unmanned device such as an unmanned driving device to implement unmanned driving is being able to perceive the surrounding environment of the device.

### SUMMARY

Embodiments in accordance with the disclosure provide an obstacle tracking method and apparatus, a storage medium, and an electronic device.

The obstacle tracking method provided in this specification includes:

obtaining obstacles in at least two frames of laser point clouds;

for every two frames of laser point clouds in the at least two frames of laser point clouds, matching the obstacles in the two frames of laser point clouds according to types of the obstacles in a former frame in the two frames of laser point clouds and types of the obstacles in a latter frame in the two frames of laser point clouds, to determine same obstacles in the former frame of laser point cloud and the latter frame of laser point cloud;

matching, according to point cloud data of unmatched obstacles in the former frame of laser point cloud and point cloud data of unmatched obstacles in the latter frame of laser point cloud, the unmatched obstacles in the two frames of laser point clouds; and

updating motion states of the obstacles in the two frames of laser point clouds according to matching results.

The obstacle tracking apparatus provided in this specification includes:

an obtaining module, configured to obtain obstacles in at least two frames of laser point clouds;

a first matching module, configured to: for every two frames of laser point clouds in the at least two frames of laser point clouds, match the obstacles in the two frames of laser point clouds according to types of the obstacles in a former frame in the two frames of laser point clouds and types of the obstacles in a latter frame in the two frames of laser point clouds, to determine same obstacles in the former frame of laser point cloud and the latter frame of laser point cloud;

a second matching module, configured to match, according to point cloud data of unmatched obstacles in the former frame of laser point cloud and point cloud data of unmatched obstacles in the latter frame of laser point cloud, the unmatched obstacles in the two frames of laser point clouds; and

an update module, configured to update motion states of the obstacles in the two frames of laser point clouds according to matching results.

This specification provides a computer-readable storage medium, storing a computer program, the computer program, when executed by a processor, implementing the foregoing obstacle tracking method.

This specification provides an electronic device, including a memory, a processor, and a computer program stored in the memory and executable on the processor, the processor being configured to implement the foregoing obstacle tracking method when executing the program.

The at least one technical solution adopted in the embodiments in accordance with the disclosure can achieve the following beneficial effects:

In the embodiments in accordance with the disclosure, for obstacles in every two frames of laser point clouds, first, the obstacles in the two frames of laser point clouds are matched for the first time according to types of the obstacles in the two frames of laser point clouds. Next, unmatched obstacles in the two frames of laser point clouds are matched for the second time according to point cloud data of the unmatched obstacles in the two frames of laser point clouds. Finally, after the two times of matching, the motion states of the obstacles in the two frames of laser point clouds are updated. In this method, the obstacles that are not successfully matched for the first time in the two frames of laser point clouds are matched for the second time. The second matching is performed based on the point cloud data of the obstacles rather than the types of the obstacles, thereby avoiding the problem that the same obstacles in the two frames of laser point clouds cannot be matched due to inaccurate obstacle detection, improving the success rate of obstacle matching in the two frames of laser point clouds, and further improving the obstacle tracking efficiency.

### BRIEF DESCRIPTION OF DRAWINGS

Accompanying drawings described herein are used for providing further understanding about this specification, and constitute a part of this specification. Exemplary embodiments in accordance with the disclosure and descriptions thereof are used for explaining this disclosure, and do not constitute an inappropriate limitation on this disclosure.

FIG. 1 is a schematic flowchart of obstacle tracking according to an embodiment of this specification.

FIG. 2a and FIG. 2b are schematic diagrams of first matching according to an embodiment of this specification.

FIG. 3 is a schematic diagram of second matching according to an embodiment of this specification.

FIG. 4 is a schematic structural diagram of an obstacle tracking apparatus according to an embodiment of this specification.

FIG. 5 is a schematic structural diagram of an electronic device according to an embodiment of this specification.

### DETAILED DESCRIPTION

In a perception process, it is necessary to first perform obstacle detection in an ambient environment of an unmanned device, and then track obstacles, so as to adjust a motion state of the unmanned device according to motion states of the tracked obstacles. The obstacle detection includes obstacle matching and update of the motion states of the obstacles. In some embodiments, the unmanned device first detects each frame of laser point cloud to obtain information of obstacles. The information of the obstacles includes at least types of the obstacles. Next, obstacles in every two frames of laser point clouds are matched only once according to the detected types of the obstacles. During matching of the obstacles in every two frames of laser point clouds, for each obstacle in the former frame in the two frames of laser point clouds, according to a matching range of the obstacle, obstacles in the matching range are selected from the obstacles in the latter frame in the two frames of laser point clouds as matching obstacles. A matching obstacle matching the obstacle is determined according to the type of the obstacle and the types of the matching obstacles, and the current motion state of the matching obstacle that is successfully matched is updated. To track surrounding obstacles in real time, obstacle matching may be performed for every two adjacent frames of laser point clouds continuously acquired by the unmanned device in the surrounding environment, and the same obstacle is continuously tracked by determining a position change of the same obstacle in every two adjacent frames of laser point clouds. Certainly, to reduce the amount of calculation for obstacle matching, obstacle matching may also be performed on two non-adjacent frames of laser point clouds acquired by the unmanned device. For example, obstacle matching is performed on the acquired first frame of laser point cloud and the acquired third frame of laser point cloud, which is not limited in this specification and may be further set as required.

However, for an obstacle that is far away from the unmanned device, due to the relatively small quantity of point clouds of the obstacle, missing detection or false detection occur during the detection of the laser point clouds of the obstacle. Using false detection as an example for description: because the obstacles in every two frames of laser point clouds are matched according to the types of the obstacles, when detection on the obstacles in the latter frame of laser point cloud is false, the obstacles in the former frame of laser point cloud cannot match the corresponding obstacles in the latter frame of laser point cloud, and the unmanned device cannot continue to track the obstacles in the former frame of laser point cloud. For example, the obstacle in the former frame of laser point cloud is a car, but the obstacle is falsely detected as a tree in the latter frame of laser point cloud. The car in the former frame of laser point cloud cannot match the tree in the latter frame of laser point cloud, causing the unmanned device to be unable to track the current motion state of the car. In addition, because the obstacle relatively far away from the unmanned device may exceed a preset matching range, when the obstacles in every two frames of laser point clouds are matched, the obstacle relatively far away from the unmanned device cannot be successfully matched. The matching range of the obstacle may be a range with a preset distance from the obstacle. For example, the matching range may be a circular region with the obstacle as the center and the preset distance as the radius.

In the embodiments in accordance with the disclosure, obstacles in every two frames of laser point clouds are matched for the first time, and obstacles that are not matched after the first matching are matched for the second time. The second matching is no longer based on the types of the obstacles, but based on point cloud data of the obstacles in every two frames of laser point clouds while the matching range is expanded, which can make up for the problem of a low success rate of obstacle matching caused by inaccurate obstacle detection (missing detection or false detection). Finally, the current motion states of the successfully matched obstacles may be updated according to matching results of the obstacles in every two frames of laser point clouds. A corresponding driving path may be planned for the unmanned device according to the current motion states of the obstacles.

To state the objectives, technical solutions, and advantages in accordance with this disclosure, the technical solutions herein will be described and illustrated below with reference to embodiments in accordance with the disclosure and corresponding accompanying drawings. Apparently, the described embodiments are merely some but not all of the embodiments, and thus are not intended to be limiting. Based on the embodiments in accordance with the disclosure, all other embodiments obtained by a person of ordinary skill in the art without creative efforts shall fall within the protection scope of this specification.

The technical solutions provided in the embodiments in accordance with the disclosure are described in detail below with reference to the accompanying drawings.

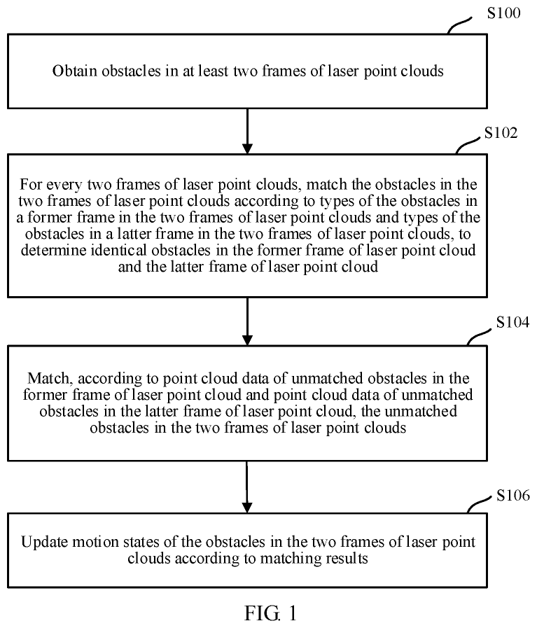

FIG. 1 is a schematic flowchart of obstacle tracking according to an embodiment of this specification. The flowchart includes the following steps.

S100: Obtain obstacles in at least two frames of laser point clouds.

In this embodiment of this specification, an unmanned device obtains laser point clouds in a surrounding environment of the unmanned device by using a laser radar. Next, obstacle detection is performed on each frame of laser point cloud to obtain obstacles in each frame of laser point cloud and types and sizes of the obstacles. During tracking of the obstacles in each frame of laser point cloud, the obstacles in at least two frames of laser point clouds may be obtained, and the obstacles in every two frames of laser point clouds are matched with each other.

S102: For every two frames of laser point clouds, match the obstacles in the two frames of laser point clouds according to types of the obstacles in a former frame in the two frames of laser point clouds and types of the obstacles in a latter frame in the two frames of laser point clouds, to determine same obstacles in the former frame of laser point cloud and the latter frame of laser point cloud.

In this embodiment of this specification, for every two frames of laser point clouds, the obstacles in the two frames of laser point clouds may be matched with each other for the first time according to the detected types of the obstacles in the two frames of laser point clouds, to determine same obstacles in the former frame of laser point cloud and the latter frame of laser point cloud.

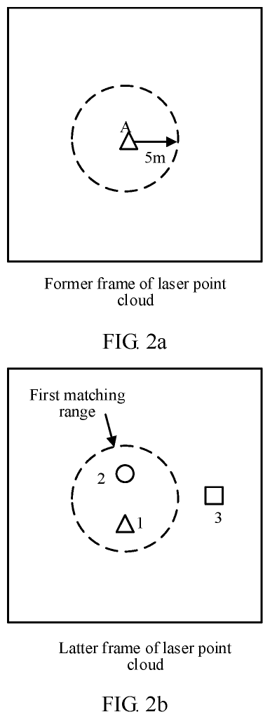

In some embodiments, each of the obstacles in the former frame of laser point cloud is used as a first obstacle. A matching range of the first obstacle is first determined as a first matching range. Next, an obstacle in the first matching range is searched for from the obstacles in the latter frame of laser point cloud, to be used as a first matching obstacle. Finally, the first obstacle may be matched with each first matching obstacle according to a type of the first obstacle and a type of each first matching obstacle, to determine a first matching obstacle matching the first obstacle. As shown in FIG. 2a and FIG. 2b,

in FIG. 2a, the first obstacle in the former frame of laser point cloud is A, and the first matching range is a circular region with the first obstacle A as the center and 5 m as the radius. In FIG. 2b, there are obstacles 1, 2, and 3 in the latter frame of laser point cloud. Only the obstacles 1 and 2 are in the first matching range, and therefore, the obstacles 1 and 2 are the first matching obstacles. The first obstacle A is respectively matched with the first obstacles 1 and 2 according to types of the obstacles to determine which of the first obstacles 1 and 2 is the same as the first obstacle A.

Further, when the first obstacle is matched with each first matching obstacle, a similarity between the first obstacle and any first matching obstacle may be calculated according to the types of the obstacles, the sizes of the obstacles, and the orientations of the obstacles. The first matching obstacle that matches the first obstacle is determined according to the similarity. The similarity may be represented by a distance between vectors. For example, features such as the types of the obstacles, the sizes of the obstacles, and the orientations of the obstacles may be converted into vectors. A similarity between a vector of the first obstacle and a vector of any first matching obstacle may be calculated according to a distance between the two vectors. A smaller distance between the two vectors indicates a higher similarity between the two vectors. The distance may be a Euclidean distance, a Manhattan distance, or the like, which is not limited in this embodiment of the present disclosure. The orientation of the obstacle may include a forward direction along a lane line and a backward direction along the lane line. The orientation of the obstacle may be alternatively a deflection direction between the obstacle and the lane line.

In some embodiments, for each first matching obstacle, a first similarity between the first obstacle and the first matching obstacle may be calculated according to the types of the obstacles, and a second similarity between the first obstacle and the first matching obstacle is calculated according to the sizes of the obstacles, and a third similarity between the first obstacle and the first matching obstacle is calculated according to the orientations of the obstacles. Next, weighted summation is performed on the first similarity, the second similarity, and the third similarity to obtain a total similarity between the first obstacle and the first matching obstacle. If the total similarity is greater than a preset threshold, the first obstacle is successfully matched with the first matching obstacle. If the total similarity is less than the preset threshold, the first obstacle fails to match the first matching obstacle.

For example, for the types of the obstacles, if the first obstacle and the first matching obstacle are of the same type, it is determined that the first similarity between the first obstacle and the first matching obstacle is 1. If the first obstacle is a person while the first matching obstacle is a car, the first similarity between the first obstacle and the first matching obstacle is 0.

S104: Match, according to point cloud data of unmatched obstacles in the former frame of laser point cloud and point cloud data of unmatched obstacles in the latter frame of laser point cloud, the unmatched obstacles in the two frames of laser point clouds.

In this embodiment of this specification, after the first matching in step S102, there are many unmatched obstacles in the two frames of laser point clouds. The unmatched obstacles may be matched for the second time according to the point cloud data of the obstacles, to increase the quantity of successfully matched obstacle matching pairs.

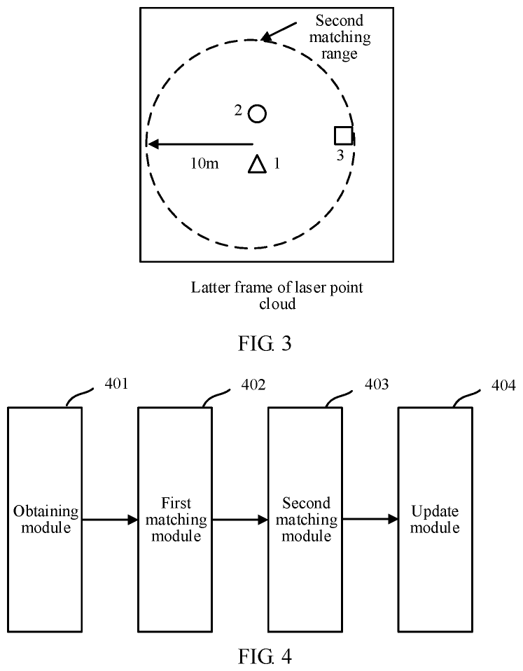

In some embodiments, each of the unmatched obstacles in the former frame of laser point cloud may be used as a target obstacle. Next, a matching range of the target obstacle is determined as a second matching range. The second matching range is larger than the first matching range. In this way, the target obstacle can be matched with more obstacles to improve the success rate of obstacle matching. Finally, each obstacle in the second matching range is searched for from the unmatched obstacles in the latter frame of laser point cloud according to the second matching range, to be used as a second matching obstacle. A second matching obstacle matching the target obstacle is determined according to point cloud data of the target obstacle and point cloud data of each second matching obstacle. Referring to FIG. 3,

with reference to the foregoing example, in FIG. 2b, if the obstacles 1 and 2 in the first matching range in the latter frame of laser point cloud cannot match the obstacle A. In FIG. 3, during the second matching, the first matching range is expanded to obtain the second matching range. The second matching range may be a circular region with the obstacle A as the center and 10 m as the radius. There are obstacles 1, 2, and 3 in the latter frame of laser point cloud. The obstacles 1, 2, and 3 are all in the second matching range, and therefore, the obstacles 1, 2, and 3 are the second matching obstacles. Next, the obstacle A is respectively matched with the second matching obstacles 1, 2, and 3 according to point cloud data of the obstacles to determine which of the second matching obstacles 1, 2, and 3 is the same as the obstacle A.

Further, when the target obstacle is matched with each second matching obstacle, a similarity between the target obstacle and any second matching obstacle may be calculated according to the quantity of point clouds and the distribution of the point clouds of each obstacle. The second matching obstacle that matches the target obstacle is determined according to the similarity.

In some embodiments, each piece of point cloud data of the target obstacle and each piece of point cloud data of each second matching obstacle may be converted into vectors, and the similarity between the target obstacle and each second matching obstacle is then calculated according to the vector of the target obstacle and the vector of each second matching obstacle. In addition, relative positions of every two pieces of point cloud data of the target obstacle and relative positions of every two pieces of point cloud data of each second matching obstacle may be converted into vectors, and the similarity between the target obstacle and each second matching obstacle is calculated according to the vectors of the target obstacle and the vectors of each second matching obstacle.

S106: Update motion states of the obstacles in the two frames of laser point clouds according to matching results.

In this embodiment of this specification, after the two times of obstacle matching in step S102 and step S104, some of the obstacles in the two frames of laser point clouds are successfully matched, and some are not. For a successfully matched obstacle matching pair, the motion state of the obstacle is updated according to the motion state of the obstacle in the latter frame of laser point cloud. The motion state includes: position, speed, acceleration, and the like.

In the case of a matching failure, if an obstacle that is not in the former frame of laser point cloud exists in the latter frame of laser point cloud, the obstacle may be added to a tracking list; if any obstacle in the former frame of laser point cloud does not exist in the latter frame of laser point cloud, missing detection may occur in the latter frame of laser point cloud. In this case, the current motion state of the obstacle may be predicted according to historical tracking data of the obstacle.

From the foregoing method shown in FIG. 1, it can be learned that in this specification, for obstacles in every two frames of laser point clouds, first, the obstacles in the two frames of laser point clouds are matched for the first time according to types of the obstacles in the two frames of laser point clouds. Next, unmatched obstacles in the two frames of laser point clouds are matched for the second time according to point cloud data of the unmatched obstacles in the two frames of laser point clouds. Finally, after the two times of matching, motion states of the obstacles in the two frames of laser point clouds are updated. In this method, the obstacles that are not successfully matched for the first time in the two frames of laser point clouds are matched for the second time. The second matching is performed based on the point cloud data of the obstacles instead of the types of the obstacles, thereby avoiding the problem that the same obstacles in the two frames of laser point clouds cannot be matched due to inaccurate obstacle detection. In addition, compared with the matching range in the first matching, the matching range in the second matching is larger, thereby improving the success rate of obstacle matching in the two frames of laser point clouds, and further improving the obstacle tracking efficiency.

Further, in step S104 shown in FIG. 1, in addition to the method of matching the target obstacle and each second matching obstacle according to the quantity of point clouds and the distribution of the point clouds, the target obstacle may be alternatively matched with each second matching obstacle according to a distance between the obstacles in the former frame of laser point cloud and the latter frame of laser point cloud.

In some embodiments, first, a central point of the target obstacle and a central point of each second matching obstacle are determined according to the point cloud data of the target obstacle and the point cloud data of each second matching obstacle. Next, for each second matching obstacle, the central point of the second matching obstacle is connected to the central point of the target obstacle to obtain a central point connection line. At least one of a transverse distance or a longitudinal distance of the central point connection line relative to a lane is determined according to the central point connection line. The transverse distance is a projection distance of the central point connection line in a direction perpendicular to the lane, and the longitudinal distance is a projection distance of the central point connection line in a direction parallel to the lane. The similarity between the second matching obstacle and the target obstacle is determined according to at least one of the transverse distance or the longitudinal distance, and the second matching obstacle that matches the target obstacle is determined according to the similarity. The longitudinal distance of the central point connection line cannot exceed a longitudinal distance obtained by projecting the second matching range in a direction parallel to the lane.

Further, during determining of the similarity between the second matching obstacle and the target obstacle, the similarity is negatively correlated with at least one of the transverse distance or the longitudinal distance. In some embodiments, given that there are fast moving vehicles in the direction parallel to the lane, the longitudinal distance in the direction parallel to the lane is not excessively limited provided that it does not exceed the second matching range. In this case, while the longitudinal distance is not limited, the transverse distance in the direction perpendicular to the lane is negatively correlated with the similarity. That is, a larger transverse distance indicates a smaller similarity between the second matching obstacle and the target obstacle. The transverse distance may be the width of the lane.

For example, if the longitudinal distance in the direction parallel to the lane is L1, and the transverse distance in the direction perpendicular to the lane is L2, because the similarity between the target obstacle and the second matching obstacle is more closely related to the transverse distance, a calculation formula of a similarity D1 obtained according to the distance between the obstacles may be: D1=0.2*L1+0.8*L2.

In addition, the similarity between the target obstacle and each second matching obstacle may be alternatively calculated according to the distance between the obstacles in the former frame of laser point cloud and the latter frame of laser point cloud and the quantities of point clouds of the obstacles.

In some embodiments, for each second matching obstacle, a fourth similarity between the target obstacle and the second matching obstacle is calculated according to the quantity of point clouds of the target obstacle and the quantity of point clouds of the second matching obstacle. A fifth similarity between the target obstacle and the second matching obstacle is calculated according to a transverse distance and a longitudinal distance, relative to the lane, between the target obstacle and the second matching obstacle. Weighted summation is performed on the fourth similarity and the fifth similarity to obtain a total similarity between the target obstacle and the second matching obstacle.

For example, if the quantity of point clouds of the target obstacle is a, the quantity of point clouds of the second matching obstacle is b, and a>b, a calculation formula of a similarity D2 obtained according to the quantities of point clouds of the obstacles may be: D2=(a−b)/a*0.2.

The method of determining, according to the similarity, the second matching obstacle that matches the target obstacle may include: determining, according to a historical count of tracking of the target obstacle, a matching threshold matching the target obstacle. The count of tracking is directly proportional to the matching threshold. That is, a larger count of tracking indicates a higher matching threshold. For a target obstacle with a larger count of tracking, it is necessary to prevent the target obstacle from being mismatched with another obstacle. In addition, to determine whether the target obstacle with a relatively large count of tracking has been mismatched, the matching threshold needs to be increased to ensure the matching accuracy.

Next, for each second matching obstacle, in a case that the similarity between the second matching obstacle and the target obstacle is greater than the matching threshold, it is determined that the second matching obstacle successfully matches the target obstacle. On the contrary, in a case that the similarity between the second matching obstacle and the target obstacle is less than the matching threshold, it is determined that the second matching obstacle fails to match the target obstacle.

In addition, to improve the matching efficiency of the unmatched obstacles in the two frames of laser point clouds, the unmatched obstacles in the two frames of laser point clouds may be filtered according to location information of the unmatched obstacles in the two frames of laser point clouds, and the selected obstacles are matched pertinently.

In some embodiments, first target obstacles may be selected from the unmatched obstacles in the former frame of laser point cloud according to the location information of the unmatched obstacles in the two frames of laser point clouds, and second target obstacles are selected from the unmatched obstacles in the latter frame of laser point cloud. The first target obstacles and the second target obstacles may be obstacles that have distances from the unmanned device greater than a preset threshold and are located in a motor vehicle lane. For example, obstacles that are 60 m away from the unmanned device and located in the motor vehicle lane are selected.

Further, for each first target obstacle, a second matching range of the first target obstacle is determined. Next, an obstacle in the second matching range is searched for from the second target obstacles, to be used as the second matching obstacle. Finally, the first target obstacle is matched with each second target obstacle according to point cloud data of the first target obstacle and point cloud data of each second target obstacle, to determine a second target obstacle that matches the first target obstacle.

The above describes the obstacle tracking method provided by the embodiments in accordance with the disclosure. Based on the same idea, a corresponding apparatus, a storage medium, and an electronic device are provided.

FIG. 4 is a schematic structural diagram of an obstacle tracking apparatus according to an embodiment of this specification. The apparatus includes:

an obtaining module 401, configured to obtain obstacles in at least two frames of laser point clouds;

a first matching module 402, configured to: for every two frames of laser point clouds in the at least two frames of laser point clouds, match the obstacles in the two frames of laser point clouds according to types of the obstacles in a former frame in the two frames of laser point clouds and types of the obstacles in a latter frame in the two frames of laser point clouds, to determine same obstacles in the former frame of laser point cloud and the latter frame of laser point cloud;

a second matching module 403, configured to match, according to point cloud data of unmatched obstacles in the former frame of laser point cloud and point cloud data of unmatched obstacles in the latter frame of laser point cloud, the unmatched obstacles in the two frames of laser point clouds; and

an update module 404, configured to update motion states of the obstacles in the two frames of laser point clouds according to matching results.

In some embodiments, the obtaining module 401 is further configured to obtain the at least two frames of laser point clouds; and for each frame of laser point cloud in the at least two frames of laser point clouds, perform obstacle detection on the laser point cloud to obtain types of the obstacles in each frame of laser point cloud.

In some embodiments, the first matching module 402 is further configured to: for each of the obstacles in the former frame of laser point cloud, use the obstacle as a first obstacle, and determine a matching range of the first obstacle as a first matching range;

according to the first matching range, search for at least one obstacle within the first matching range from the obstacles in the latter frame of laser point cloud, as at least one first matching obstacle; and determine, according to a type of the first obstacle and a type of the at least one first matching obstacle, a first matching obstacle matching the first obstacle from the at least one first matching obstacle.

In some embodiments, the second matching module 403 is further configured to: for each of the unmatched obstacles in the former frame of laser point cloud, use the obstacle as a target obstacle, and determine a matching range of the target obstacle as a second matching range; according to the second matching range, search for at least one obstacle within the second matching range from the unmatched obstacles in the latter frame of laser point cloud, as at least one second matching obstacle; and determine, according to point cloud data of the target obstacle and point cloud data of the at least one second matching obstacle, a second matching obstacle matching the target obstacle from the at least one second matching obstacle, where the second matching range is larger than the first matching range.

In some embodiments, the second matching module 403 is further configured to: select, according to location information of the unmatched obstacles in the two frames of laser point clouds, a first target obstacle from the unmatched obstacles in the former frame of laser point cloud, and select a second target obstacle from the unmatched obstacles in the latter frame of laser point cloud; and match the first target obstacle in the former frame of laser point cloud with the second target obstacle in the latter frame of laser point cloud.

In some embodiments, the second matching module 403 is further configured to: determine a central point of the target obstacle and a central point of each second matching obstacle in the at least one second matching obstacle according to the point cloud data of the target obstacle and the point cloud data of the at least one second matching obstacle; for each second matching obstacle in the at least one second matching obstacle, connect the central point of the second matching obstacle to the central point of the target obstacle to obtain a central point connection line; determine at least one of a transverse distance or a longitudinal distance of the central point connection line relative to a lane according to the central point connection line; determine a similarity between the second matching obstacle and the target obstacle according to at least one of the transverse distance or the longitudinal distance; and determine, according to the similarity, the second matching obstacle matching the target obstacle from the at least one second matching obstacle.

In some embodiments, the second matching module 403 is further configured to: determine, according to a historical count of tracking of the target obstacle, a matching threshold matching the target obstacle, where the count of tracking is positively correlated with the matching threshold; and for each second matching obstacle in the at least one second matching obstacle, determine, in response to determination that the similarity between the second matching obstacle and the target obstacle is greater than the matching threshold, that the second matching obstacle matches the target obstacle.

This specification further provides a computer-readable storage medium, storing a computer program, the computer program, when executed by a processor, being configured to implement the foregoing obstacle tracking method shown in FIG. 1.

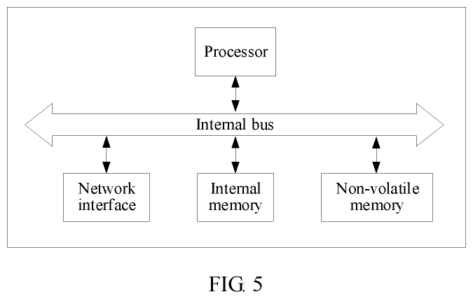

Based on the obstacle tracking method shown in FIG. 1, the embodiments in accordance with the disclosure further provide a schematic structural diagram of an unmanned device shown in FIG. 5. Referring to FIG. 5, at a hardware level, the unmanned device includes a processor, an internal bus, a network interface, an internal memory, and a non-volatile memory, and may certainly further include hardware required for other services. The processor reads a corresponding computer program from the non-volatile storage into the memory and then runs the computer program to implement the obstacle tracking method shown in FIG. 1.

Definitely, in addition to a software implementation, this specification does not exclude other implementations, for example, a logic device or a combination of software and hardware. In other words, an entity executing the following processing procedure is not limited to the logic units, and may also be hardware or logic devices.

In the 1990s, improvements of a technology can be clearly distinguished between hardware improvements (for example, improvements to a circuit structure such as a diode, a transistor, or a switch) and software improvements (improvements to a method procedure). However, with the development of technology, improvements of many method procedures can be considered as direct improvements of hardware circuit structures. Designers almost all program an improved method procedure to a hardware circuit, to obtain a corresponding hardware circuit structure. Therefore, it does not mean that the improvement of a method procedure cannot be implemented by using a hardware entity module. For example, a programmable logic device (PLD) such as a field programmable gate array (FPGA) is a type of integrated circuit whose logic function is determined by a user by programming the device. The designers perform voluntary programming to “integrate” a digital system into a single PLD without requiring a chip manufacturer to design and prepare a dedicated integrated circuit chip. Moreover, nowadays, instead of manually making integrated circuit chips, this programming is mostly implemented by using “logic compiler” software, which is similar to the software compiler used in program development and writing. The original code is written in a specific programming language before compiling, and this language is referred to as a hardware description language (HDL). There are various kinds of HDLs, for example, advanced Boolean expression language (ABEL), altera hardware description language (AHDL), Confluence, Cornell university programming language (CUPL), HDCal, Java hardware description language (JHDL), Lava, Lola, MyHDL, PALASM, Ruby hardware description language (RHDL), and the like. Currently, the most commonly used HDLs are very-high-speed integrated circuit hardware description language (VHDL) and Verilog. A person skilled in the art should also understand that provided that a method procedure is logically programmed and then programmed to an integrated circuit by using the foregoing hardware description languages, a hardware circuit that implements the logical method procedure can be easily obtained.

The controller can be implemented in any suitable manner, for example, the controller can take the form of, for example, a microprocessor or processor and a computer-readable medium storing computer-readable program code (for example, software or firmware) executable by the processor, a logic gate, a switch, an application-specific integrated circuit (ASIC), a programmable logic controller and an embedded microcontroller. Examples of the controller include, but are not limited to, the following microcontrollers: ARC 625D, Atmel AT91SAM, Microchip PIC18F26K20, and Silicone Labs C8051F320. The memory controller can also be implemented as part of the memory control logic. A person skilled in the art will also appreciate that, in addition to implementing the controller in the form of pure computer-readable program code, it is also possible to implement, by logically programming the method steps, the controller in the form of a logic gate, switch, ASIC, programmable logic controller, and embedded microcontroller and other forms to achieve the same function. Such a controller can thus be considered as a hardware component and apparatuses included therein for implementing various functions can also be considered as structures inside the hardware component. Alternatively, apparatuses configured to implement various functions can be considered as both software modules implementing the method and structures inside the hardware component.

The system, the apparatus, the module or the unit described in the foregoing embodiments may be implemented by a computer chip or an entity In some embodiments, or implemented by a product having a certain function. A typical implementation device is a computer. In some embodiments, the computer may be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into units according to functions, which are separately described. Certainly, during implementation of this specification, the functions of the units may be implemented in the same piece of or a plurality of pieces of software and/or hardware.

A person skilled in the art should understand that the embodiments in accordance with the disclosure may be provided as a method, a system, or a computer program product. Therefore, this specification may use a form of hardware only embodiments, software only embodiments, or embodiments with a combination of software and hardware. Moreover, this specification may use a form of a computer program product that is implemented on one or more computer-usable storage media (including but not limited to a disk memory, a CD-ROM, an optical memory, and the like) that include computer-usable program code.

This specification is described with reference to the flowcharts and/or block diagrams of the method, the device (system), and the computer program product according to the embodiments in accordance with the disclosure. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

These computer program instructions may also be stored in a computer readable memory that can instruct a computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

In a typical configuration, the computer device includes one or more processors (CPUs), an input/output interface, a network interface, and a memory.

The memory may include a form such as a volatile memory, a random-access memory (RAM) and/or a non-volatile memory such as a read-only memory (ROM) or a flash RAM in a computer-readable medium. The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition in the present disclosure, the computer-readable medium does not include transitory computer readable media (transitory media), such as a modulated data signal and a carrier.

It should be further noted that the term “include,” “comprise,” or any other variants are intended to cover a non-exclusive inclusion, so that a process, a method, a commodity, or a device that includes a series of elements not only includes such elements, but also includes other elements not expressly listed, or further includes elements inherent to such a process, method, commodity, or device. Unless otherwise specified, an element limited by “include a/an . . . ” does not exclude other same elements existing in the process, the method, the article, or the device that includes the element.

A person skilled in the art should understand that the embodiments in accordance with the disclosure may be provided as a method, a system, or a computer program product. Therefore, this specification may use a form of hardware only embodiments, software only embodiments, or embodiments with a combination of software and hardware. Moreover, this specification may use a form of a computer program product that is implemented on one or more computer-usable storage media (including but not limited to a disk memory, a CD-ROM, an optical memory, and the like) that include computer-usable program code.

This specification can be described in the general context of computer-executable instructions executed by a computer, for example, program modules. Generally, the program module includes a routine, a program, an object, a component, a data structure, and the like for executing a particular task or implementing a particular abstract data type. This specification may also be implemented in a distributed computing environment in which tasks are performed by remote processing devices connected by using a communication network. In a distributed computing environment, the program module may be located in both local and remote computer storage media including storage devices.

The embodiments in accordance with the disclosure are all described in a progressive manner, for same or similar parts in the embodiments, refer to these embodiments, and descriptions of each embodiment focus on a difference from other embodiments. Especially, a system embodiment is basically similar to a method embodiment, and therefore is described briefly; for related parts, reference may be made to partial descriptions in the method embodiment.

The descriptions are merely embodiments in accordance with the disclosure, and are not intended to limit this specification. For a person skilled in the art, various modifications and changes may be made to this specification. Any modifications, equivalent replacements, and improvements made within the spirit and principle of this specification shall fall within the scope of the claims of this specification.

What is claimed is:

1. An obstacle tracking method, comprising:
obtaining obstacles in at least two frames of laser point clouds;
for every two frames of laser point clouds in the at least two frames of laser point clouds,
matching the obstacles in the two frames of laser point clouds according to types of the obstacles in a former frame in the two frames of laser point clouds and types of the obstacles in a latter frame in the two frames of laser point clouds, to determine same obstacles in the former frame and the latter frame;
matching, according to point cloud data of unmatched obstacles in the former frame of laser point cloud and point cloud data of unmatched obstacles in the latter frame, the unmatched obstacles in the two frames of laser point clouds; and
updating motion states of the obstacles in the two frames of laser point clouds according to matching results.

2. The method according to claim 1, wherein obtaining obstacles in the at least two frames of laser point clouds comprises:
obtaining the at least two frames of laser point clouds; and
performing obstacle detection on the at least two frames of laser point clouds to obtain types of the obstacles in each of the at least two frames of laser point clouds.

3. The method according to claim 1, wherein matching the obstacles in the two frames of laser point clouds according to types of the obstacles in the former frame in the two frames of laser point clouds and types of the obstacles in the latter frame in the two frames of laser point clouds comprises:
for each of the obstacles in the former frame,
with the obstacle as a first obstacle, determining a matching range of the first obstacle as a first matching range;
according to the first matching range, searching for at least one obstacle within the first matching range from the obstacles in the latter frame, as at least one first matching obstacle; and
determining, according to a type of the first obstacle and a type of the at least one first matching obstacle, a first matching obstacle matching the first obstacle from the at least one first matching obstacle.

4. The method according to claim 3, wherein matching, according to point cloud data of unmatched obstacles in the former frame and point cloud data of unmatched obstacles in the latter frame, the unmatched obstacles in the two frames of laser point clouds comprises:
for each of the unmatched obstacles in the former frame,
with the unmatched obstacle as a target obstacle, determining a matching range of the target obstacle as a second matching range;
according to the second matching range, searching for at least one obstacle within the second matching range from the unmatched obstacles in the latter frame, as at least one second matching obstacle; and
determining, according to point cloud data of the target obstacle and point cloud data of the at least one second matching obstacle, a second matching obstacle matching the target obstacle from the at least one second matching obstacle, wherein the second matching range is larger than the first matching range.

5. The method according to claim 4, wherein determining, according to point cloud data of the target obstacle and point cloud data of the at least one second matching obstacle, the second matching obstacle matching the target obstacle from the at least one second matching obstacle comprises:
determining a central point of the target obstacle and a central point of each of the at least one second matching obstacle according to the point cloud data of the target obstacle and the point cloud data of the at least one second matching obstacle;
for each of the at least one second matching obstacle,
connecting the central point of the second matching obstacle to the central point of the target obstacle to obtain a central point connection line;
determining at least one of a transverse distance or a longitudinal distance of the central point connection line relative to a lane according to the central point connection line;
determining a similarity between the second matching obstacle and the target obstacle according to at least one of the transverse distance or the longitudinal distance; and
determining, according to the similarity, the second matching obstacle matching the target obstacle from the at least one second matching obstacle.

6. The method according to claim 5, wherein the determining, according to the similarity, the second matching obstacle matching the target obstacle from the at least one second matching obstacle comprises:
determining, according to a count of tracking for the target obstacle in previous, a matching threshold matching the target obstacle, wherein the count of tracking is positively correlated with the matching threshold; and
for each of the at least one second matching obstacle, determining, in response to determination that the similarity between the second matching obstacle and the target obstacle is greater than the matching threshold, that the second matching obstacle matches the target obstacle.

7. The method according to claim 1, wherein matching, according to point cloud data of unmatched obstacles in the former frame and point cloud data of unmatched obstacles in the latter frame, the unmatched obstacles in the two frames of laser point clouds comprises:
selecting, according to location information of the unmatched obstacles in the two frames of laser point clouds, at least one first target obstacle from the unmatched obstacles in the former frame, and at least one second target obstacle from the unmatched obstacles in the latter frame; and
matching the at least one first target obstacle in the former frame with the at least one second target obstacle in the latter frame.

8. A non-transitory computer-readable storage medium, having stored thereon a computer program such that when the computer program is executed by a processor, the processor is caused to perform:
obtaining obstacles in at least two frames of laser point clouds;
for every two frames of laser point clouds in the at least two frames of laser point clouds,
matching the obstacles in the two frames of laser point clouds according to types of the obstacles in a former frame in the two frames of laser point clouds and types of the obstacles in a latter frame in the two frames of laser point clouds, to determine same obstacles in the former frame and the latter frame;
matching, according to point cloud data of unmatched obstacles in the former frame and point cloud data of unmatched obstacles in the latter frame, the unmatched obstacles in the two frames of laser point clouds; and
updating motion states of the obstacles in the two frames of laser point clouds according to matching results.

9. The non-transitory computer-readable storage medium according to claim 8, wherein matching the obstacles in the two frames of laser point clouds according to types of the obstacles in the former frame in the two frames of laser point clouds and types of the obstacles in the latter frame in the two frames of laser point clouds comprises:
for each of the obstacles in the former frame,
with the obstacle as a first obstacle, determining a matching range of the first obstacle as a first matching range;
according to the first matching range, searching for at least one obstacle within the first matching range from the obstacles in the latter frame, as at least one first matching obstacle; and
determining, according to a type of the first obstacle and a type of the at least one first matching obstacle, a first matching obstacle matching the first obstacle from the at least one first matching obstacle.

10. The non-transitory computer-readable storage medium according to claim 9, wherein matching, according to point cloud data of unmatched obstacles in the former frame and point cloud data of unmatched obstacles in the latter frame, the unmatched obstacles in the two frames of laser point clouds comprises:
for each of the unmatched obstacles in the former frame,
with the unmatched obstacle as a target obstacle, determining a matching range of the target obstacle as a second matching range;
according to the second matching range, searching for at least one obstacle within the second matching range from the unmatched obstacles in the latter frame, as at least one second matching obstacle; and
determining, according to point cloud data of the target obstacle and point cloud data of the at least one second matching obstacle, a second matching obstacle matching the target obstacle from the at least one second matching obstacle, wherein the second matching range is larger than the first matching range.

11. The non-transitory computer-readable storage medium according to claim 10, wherein determining, according to point cloud data of the target obstacle and point cloud data of the at least one second matching obstacle, the second matching obstacle matching the target obstacle from the at least one second matching obstacle comprises:
determining a central point of the target obstacle and a central point of each of the at least one second matching obstacle according to the point cloud data of the target obstacle and the point cloud data of the at least one second matching obstacle;
for each of the at least one second matching obstacle,
connecting the central point of the second matching obstacle to the central point of the target obstacle to obtain a central point connection line;
determining at least one of a transverse distance or a longitudinal distance of the central point connection line relative to a lane according to the central point connection line;
determining a similarity between the second matching obstacle and the target obstacle according to at least one of the transverse distance or the longitudinal distance; and
determining, according to the similarity, the second matching obstacle matching the target obstacle from the at least one second matching obstacle.

12. The non-transitory computer-readable storage medium according to claim 11, wherein the determining, according to the similarity, the second matching obstacle matching the target obstacle from the at least one second matching obstacle comprises:
determining, according to a count of tracking for the target obstacle in previous, a matching threshold matching the target obstacle, wherein the count of tracking is positively correlated with the matching threshold; and
for each of the at least one second matching obstacle, determining, in response to determination that the similarity between the second matching obstacle and the target obstacle is greater than the matching threshold, that the second matching obstacle matches the target obstacle.

13. The non-transitory computer-readable storage medium according to claim 8, wherein matching, according to point cloud data of unmatched obstacles in the former frame and point cloud data of unmatched obstacles in the latter frame, the unmatched obstacles in the two frames of laser point clouds comprises:
selecting, according to location information of the unmatched obstacles in the two frames of laser point clouds, at least one first target obstacle from the unmatched obstacles in the former frame, and at least one second target obstacle from the unmatched obstacles in the latter frame; and
matching the at least one first target obstacle in the former frame with the at least one second target obstacle in the latter frame.

14. An electronic device, comprising a memory, a processor, and a computer program stored in the memory and executable by the processor such that when the computer program is executed, the processor is caused to perform:
obtaining obstacles in at least two frames of laser point clouds;
for every two frames of laser point clouds in the at least two frames of laser point clouds,
matching the obstacles in the two frames of laser point clouds according to types of the obstacles in a former frame in the two frames of laser point clouds and types of the obstacles in a latter frame in the two frames of laser point clouds, to determine same obstacles in the former frame and the latter frame;
matching, according to point cloud data of unmatched obstacles in the former frame and point cloud data of unmatched obstacles in the latter frame, the unmatched obstacles in the two frames of laser point clouds; and
updating motion states of the obstacles in the two frames of laser point clouds according to matching results.

15. The electronic device according to claim 14, wherein obtaining obstacles in the at least two frames of laser point clouds comprises:
obtaining the at least two frames of laser point clouds; and
performing obstacle detection on the at least two frames of laser point clouds to obtain types of the obstacles in each of the at least two frames of laser point clouds.

16. The electronic device according to claim 14, wherein matching the obstacles in the two frames of laser point clouds according to types of the obstacles in the former frame in the two frames of laser point clouds and types of the obstacles in the latter frame in the two frames of laser point clouds comprises:
for each of the obstacles in the former frame,
with the obstacle as a first obstacle, determining a matching range of the first obstacle as a first matching range;
according to the first matching range, searching for at least one obstacle within the first matching range from the obstacles in the latter frame, as at least one first matching obstacle; and
determining, according to a type of the first obstacle and a type of the at least one first matching obstacle, a first matching obstacle matching the first obstacle from the at least one first matching obstacle.

17. The electronic device according to claim 16, wherein matching, according to point cloud data of unmatched obstacles in the former frame and point cloud data of unmatched obstacles in the latter frame, the unmatched obstacles in the two frames of laser point clouds comprises:
for each of the unmatched obstacles in the former frame,
with the unmatched obstacle as a target obstacle, determining a matching range of the target obstacle as a second matching range;
according to the second matching range, searching for at least one obstacle within the second matching range from the unmatched obstacles in the latter frame, as at least one second matching obstacle; and
determining, according to point cloud data of the target obstacle and point cloud data of the at least one second matching obstacle, a second matching obstacle matching the target obstacle from the at least one second matching obstacle, wherein the second matching range is larger than the first matching range.

18. The electronic device according to claim 17, wherein determining, according to point cloud data of the target obstacle and point cloud data of the at least one second matching obstacle, the second matching obstacle matching the target obstacle from the at least one second matching obstacle comprises:
determining a central point of the target obstacle and a central point of each of the at least one second matching obstacle according to the point cloud data of the target obstacle and the point cloud data of the at least one second matching obstacle;
for each of the at least one second matching obstacle,
connecting the central point of the second matching obstacle to the central point of the target obstacle to obtain a central point connection line;
determining at least one of a transverse distance or a longitudinal distance of the central point connection line relative to a lane according to the central point connection line;
determining a similarity between the second matching obstacle and the target obstacle according to at least one of the transverse distance or the longitudinal distance; and
determining, according to the similarity, the second matching obstacle matching the target obstacle from the at least one second matching obstacle.

19. The electronic device according to claim 18, wherein the determining, according to the similarity, the second matching obstacle matching the target obstacle from the at least one second matching obstacle comprises:
determining, according to a count of tracking for the target obstacle in previous, a matching threshold matching the target obstacle, wherein the count of tracking is positively correlated with the matching threshold; and
for each of the at least one second matching obstacle, determining, in response to determination that the similarity between the second matching obstacle and the target obstacle is greater than the matching threshold, that the second matching obstacle matches the target obstacle.

20. The electronic device according to claim 14, wherein matching, according to point cloud data of unmatched obstacles in the former frame and point cloud data of unmatched obstacles in the latter frame, the unmatched obstacles in the two frames of laser point clouds comprises:
selecting, according to location information of the unmatched obstacles in the two frames of laser point clouds, at least one first target obstacle from the unmatched obstacles in the former frame, and at least one second target obstacle from the unmatched obstacles in the latter frame; and
matching the at least one first target obstacle in the former frame with the at least one second target obstacle in the latter frame.
